(19) United States
(12) Patent Application Publication
(10) Pub. No.: US 2016/0362038 A1
(43) Pub. Date: Dec. 15, 2016

(54) System and Method for Restraining a Vehicle

(71) Applicants: Jerry W. Vande Sande, Dallas, TX (US); Robert J. Cencer, Tipton, MI (US); Andrew Brown, Plano, TX (US); George S. Creighton, Pompano Beach, FL (US)

(72) Inventors: Jerry W. Vande Sande, Dallas, TX (US); Robert J. Cencer, Tipton, MI (US); Andrew Brown, Plano, TX (US); George S. Creighton, Pompano Beach, FL (US)

(21) Appl. No.: 14/735,977

(22) Filed: Jun. 10, 2015

(51) Int. Cl. B60P 3/077; B60P 7/08; B61D 3/18

(52) U.S. Cl. CPC B60P 3/077; B61D 3/18; B61D 3/187; B60P 7/0853; B60P 7/0807

(57) ABSTRACT

A system for restraining a vehicle includes a deck of a transport. The deck includes a track assembly comprising a plurality of plates. The system also includes a strap assembly configured to secure a vehicle to the deck of the transport. The strap assembly is also configured to be coupled to the deck of the transport through a first plate of the plurality of plates of the track assembly and a second plate of the plurality of plates of the track assembly.

### TECHNICAL FIELD

The present disclosure relates generally to transports, and more particularly to a system and method for restraining a vehicle.

### BACKGROUND

Automobile manufacturers often transport vehicles via railroad lines on multi-deck railcars, such as autoracks. In general, larger vehicles (such as trucks and SUVs) are transported on bi-level autoracks and smaller vehicles (such as compact cars and sedans) are transported on tri-level autoracks. Conventional systems for restraining vehicles during transport vary depending on the type of autorack. For example, bi-level autoracks typically employ wheel chocks that attach to steel wire grating panels fastened to the driving surface of a deck of the autorack (“bi-level vehicle restraint system”), while tri-level autoracks typically employ wheel chocks that attach to and are cantilevered over a raised “hat” shaped steel extrusion welded to the deck adjacent to the driving surface (“tri-level vehicle restraint system”). Moreover, bi-level vehicle restraint systems are often designed to effectively secure larger vehicles, but not smaller vehicles. And tri-level vehicle restraint systems are usually designed to effectively secure smaller vehicles, but not larger vehicles.

When consumer demand for certain types and/or sizes of vehicles changes, so does the demand for certain types of autoracks. Such changes frequently cause shortages in supply of one type of autorack and force autorack operators to invest in new equipment to meet demand and place out-of-demand equipment in storage. In response to the negative impacts of these changes in market demand, railcar manufacturers developed convertible autorack railcars. But while convertible autoracks may be configured as bi-level and tri-level autoracks (e.g., by adding and removing a deck to respond to a current market demand), the majority of convertible autoracks utilize the conventional vehicle restraint systems employed by existing bi-level and tri-level autoracks. As a result, converting these autoracks from bi-level to tri-level (and vice versa) requires switching from one type of vehicle restraint system to another (e.g., removing bi-level vehicle restraint systems and installing tri-level vehicle restraint systems (and vice versa)), usually at great time and expense.

### SUMMARY

The teachings of the present disclosure relate to a system and method for restraining a vehicle. In accordance with one embodiment, a system for restraining a vehicle includes a deck of a transport. The deck includes a track assembly comprising a plurality of plates. The system also includes a strap assembly configured to secure a vehicle to the deck of the transport. The strap assembly is also configured to be coupled to the deck of the transport through a first plate of the plurality of plates of the track assembly and a second plate of the plurality of plates of the track assembly.

In accordance with another embodiment, a method for restraining a vehicle includes positioning a strap assembly over a portion of a tire of a vehicle to secure the vehicle to a deck of a transport. The deck comprises a track assembly and the track assembly comprises a plurality of plates. The method also includes coupling a first end of the strap assembly to a first plate of the plurality of plates of the track assembly. A second end of the strap assembly is coupled to a second plate of the plurality of plates of the track assembly.

In accordance with yet another embodiment, a system for restraining a vehicle includes a deck of transport. The deck includes a plurality of slots. The system also includes a strap assembly configured to secure a vehicle to the deck of the transport. The strap assembly is further configured to be coupled to the deck of the transport through a first slot of the plurality of slots of the deck and a second slot of the plurality of slots of the deck.

Technical advantages of particular embodiments may include providing a universal deck integrated vehicle restraint system that may be used in both bi-level and tri-level autorack railcars, as well as convertible autorack railcars. Such a system accommodates small and large vehicles alike, regardless of variations in size and wheel track width, which in turn reduces the costs associated with operating and manufacturing transports, and in particular autoracks.

Further technical advantages of particular embodiments may include a vehicle restraint system that allows for flexibility in the transverse positioning of vehicles, thereby providing more room for operators of autoracks to access vehicles being transported on autoracks. As a result, safety hazards associated with operating autoracks and other transports may be eliminated and/or reduced.

Another technical advantage of particular embodiments may include providing a vehicle restraint system that is lighter in weight than conventional vehicle restraint systems for bi-level and tri-level autoracks.

Additional technical advantages may include integrating a track assembly of a vehicle restraint system directly into a deck of a transport, thereby eliminating the need to install and/or remove existing restraint mechanisms when converting an autorack from a bi-level configuration to a tri-level configuration and vice versa, which in turn reduces the amount of time and manpower required to operate transports (such as railcars). Doing so may also eliminate and/or reduce any wear and tear of a transport that may result from installing and removing vehicle restraint mechanisms. Thus, the costs associated with maintaining and operating transports may be reduced. A further technical advantage of integrating the track assembly directly into decks of a transport may include increasing the amount of vertical clearance between the decks. Such vertical clearance is often critical in the transportation of vehicles in autorack railcars.

Yet another technical advantage may include a vehicle restraint system that simplifies the loading and unloading of vehicles. For example, the amount of precision required to safely load and secure vehicles to a deck of a transport may be reduced.

Other technical advantages will be readily apparent to one of ordinary skill in the art from the following figures, descriptions, and claims included herein. Moreover, while specific advantages have been enumerated above, certain embodiments of the invention may include all, some, or none of the enumerated advantages.

### BRIEF DESCRIPTION OF THE DRAWINGS

A more complete and thorough understanding of the particular embodiments and advantages thereof may be acquired by referring to the following description taken in conjunction with the accompanying drawings, in which like reference numbers indicate like features, and wherein:

FIG. 1A illustrates a side view of an example transport of a system for restraining a vehicle in accordance with an embodiment of the present disclosure;

FIG. 1B illustrates a perspective view of an example transport of a system for restraining a vehicle in accordance with an embodiment of the present disclosure;

FIG. 2 illustrates a perspective view of an example of a system for restraining a vehicle in accordance with an embodiment of the present disclosure;

FIG. 3 illustrates a top view of an example of a system for restraining a vehicle in accordance with an embodiment of the present disclosure;

FIG. 4 illustrates an end view of an example deck of a system for restraining a vehicle in accordance with an embodiment of the present disclosure;

FIG. 5 illustrates a side view of an example system for restraining a vehicle in accordance with an embodiment of the present disclosure;

FIG. 6 illustrates a perspective view of an example of a strap assembly coupled to a track assembly to secure a vehicle to a deck of a transport in accordance with an embodiment of the present disclosure;

FIG. 7A illustrates an example ratchet of a system for restraining a vehicle in accordance with an embodiment of the present disclosure;

FIG. 7B illustrates an example anchor of a system for restraining a vehicle in accordance with an embodiment of the present disclosure;

FIG. 7C illustrates a side view of an example wheel chock of a system for restraining a vehicle in accordance with an embodiment of the present disclosure;

FIG. 7D illustrates a side view of an example strap of a system for restraining a vehicle in accordance with an embodiment of the present disclosure;

FIG. 8 illustrates an example method for restraining a vehicle in accordance with an embodiment of the present disclosure;

FIG. 9 illustrates a perspective view of another example deck of a system for restraining a vehicle in accordance with an embodiment of the present disclosure; and

FIG. 10 illustrates a side view of an example chock assembly of a system for restraining a vehicle in accordance with an embodiment of the present disclosure.

### DETAILED DESCRIPTION

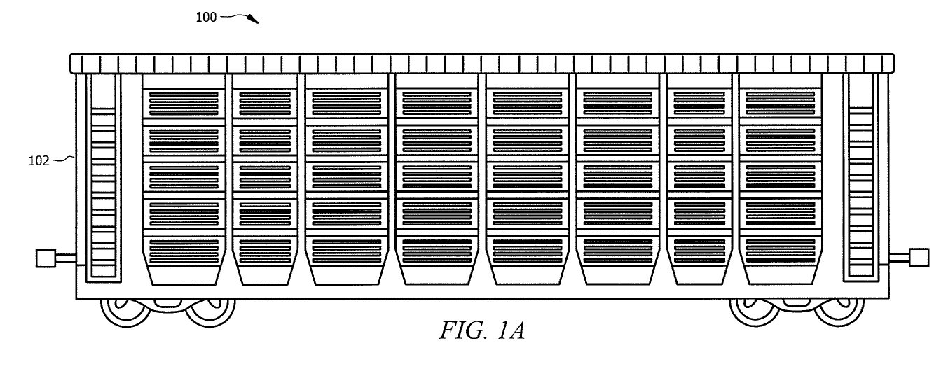

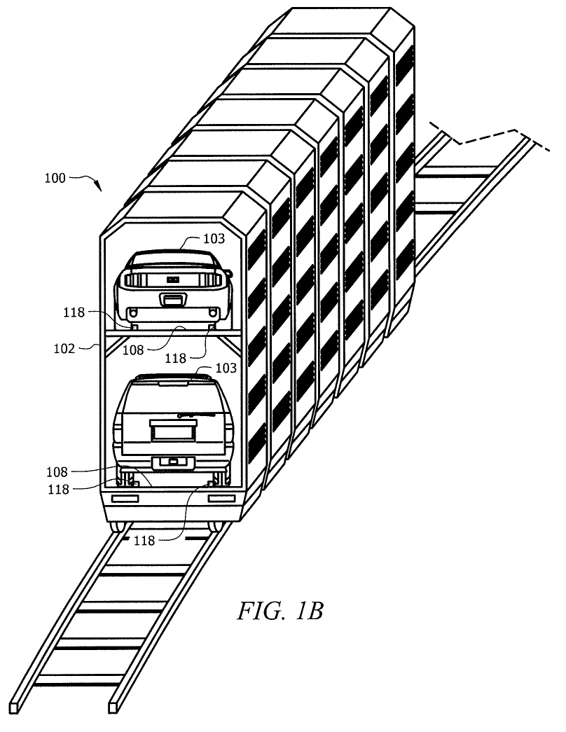

Particular embodiments of the present disclosure and its advantages are best understood by reference to FIGS. 1A through 10 of the drawings, like numerals being used for like and corresponding parts of the various drawings.

Automobile manufacturers often transport vehicles via railroad lines on multi-deck railcars, such as autoracks. In general, larger vehicles (such as trucks and SUVs) are transported on bi-level autoracks and smaller vehicles (such as compact cars and sedans) are transported on tri-level autoracks. Conventional systems for restraining vehicles during transport vary depending on the type of autorack. For example, bi-level autoracks typically employ wheel chocks that attach to steel wire grating panels fastened to the driving surface of a deck of the autorack (“bi-level vehicle restraint system”), while tri-level autoracks typically employ wheel chocks that attach to and are cantilevered over a raised “hat” shaped steel extrusion welded to the deck adjacent to the driving surface (“tri-level vehicle restraint system”). Moreover, bi-level vehicle restraint systems are often designed to effectively secure larger vehicles, but not smaller vehicles. And tri-level vehicle restraint systems are usually designed to effectively secure smaller vehicles, but not larger vehicles.

When consumer demand for certain types and/or sizes of vehicles changes, so does the demand for certain types of autoracks. Such changes frequently cause shortages in supply of one type of autorack and force autorack operators to invest in new equipment to meet demand and place out-of-demand equipment in storage. In response to the negative impacts of these changes in market demand, railcar manufacturers developed convertible autorack railcars. But while convertible autoracks may be configured as bi-level and tri-level autoracks (e.g., by adding and removing a deck to respond to a current market demand), the majority of convertible autoracks utilize the conventional vehicle restraint systems employed by existing bi-level and tri-level autoracks. As a result, converting these autoracks from bi-level to tri-level (and vice versa) requires switching from one type of vehicle restraint system to another (e.g., removing bi-level vehicle restraint systems and installing tri-level vehicle restraint systems (and vice versa)), usually at great time and expense. The teachings of the present disclosure recognize that it would be desirable to provide a system and method for restraining a vehicle using a universal deck integrated restraint system that may secure various types and sizes of vehicles to a deck of transport.

FIGS. 1A through 1B illustrate a side view and a perspective view, respectively, of an example transport of a system for restraining a vehicle in accordance with an embodiment of the present disclosure. System 100 generally refers to a universal vehicle restraint system for securing vehicles during shipment. In particular, system 100 may be used to secure any type of vehicle having any width (e.g., vehicles of different track widths—a distance from the midline of one tire to the midline of the opposite tire and/or a distance between the outside tread edge of one tire and the outside tread edge of the opposite tire on the same axle)) to a deck of a transport (e.g., a deck of an autorack). For example, a first type of vehicle, such as a car, with a first track width may be secured to the deck of the transport and a second type of vehicle, such as a truck, with a second track width (greater than the first track width) also may be secured to the deck of the transport. In other words, regardless of variations in wheel track width, both small vehicles and large vehicles may be secured to the same deck of a transport.

System 100 may be implemented in any type of autorack and/or other transport, such as a transport 102. A transport 102 may comprise any type of carrier capable of transporting vehicles 103 and may refer to an autorack 102. Example autoracks 102 may include railcars, trailers, tractor trailers, ships, airplanes, trucks, and/or any other carrier capable of transporting vehicles 103. In certain embodiments, an autorack 102 may be a convertible autorack that may be configured as a tri-level autorack (e.g., a railcar comprising three decks) and a bi-level autorack (e.g., a railcar comprising two decks). For example, a convertible autorack may be converted from a bi-level configuration to a tri-level configuration by adding a deck within the autorack. Alternatively, a convertible autorack may be converted from a tri-level autorack to a bi-level autorack by removing a deck from within the autorack.

In general, system 100 facilitates transporting vehicles 103 via transports 102. Examples of vehicles 103 may include cars (e.g., compact cars, sedans, etc.), jeeps, SUVs, trucks, buses, boats, aircrafts, any other automobile, any other machine having one or more tires, and/or any combination of the preceding. The present disclosure contemplates system 100 transporting any type of vehicle 103 of any size.

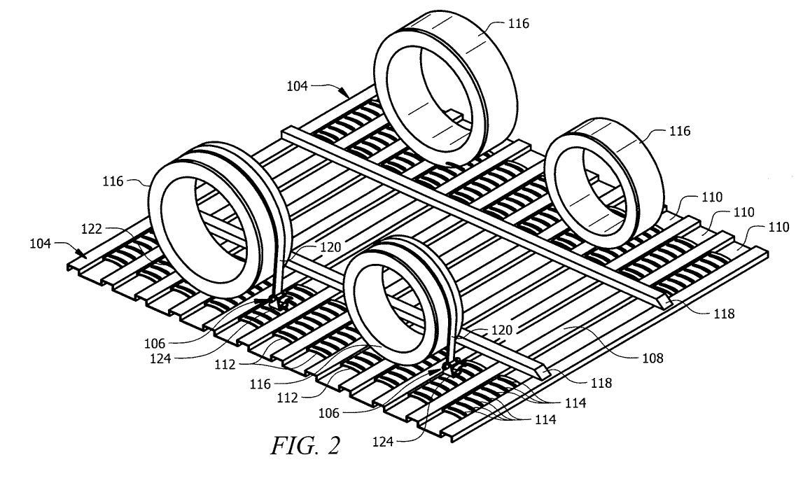

As discussed below with regard to FIG. 2, transport 102 may include one or more decks 108 comprising tire guides 118. Although FIGS. 1A through 1B illustrate system 100 as including one transport 102, two vehicles 103, and two decks 108, system 100 may include any suitable number of transports 102, vehicles 103, and decks 108. Further, although particular examples of transports 102 have been described, this disclosure contemplates any suitable transports 102 comprising any suitable components configured in any suitable manner, according to particular needs.

FIG. 2 illustrates a perspective view of an example of a system for restraining a vehicle in accordance with an embodiment of the present disclosure. System 100 may include one or more track assemblies 104, strap assemblies 106, and decks 108. In general, system 100 uses track assemblies 104 and strap assemblies 106 to secure different types of vehicles of different widths (e.g., vehicles 103 of different sizes with different track widths) to one or more decks 108 of a transport, such as transport 102.

A deck 108 may include a track assembly 104 and may be configured to support one or more vehicles 103. Example decks 108 may be formed from steel and/or any other suitable material. As illustrated in FIG. 2, deck 108 may be a corrugated deck and may include a plurality of recesses 110. In certain embodiments, one or more decks 108 of transport 102 may be adjustable and/or removable, thereby enabling transport 102 to be used as a bi-level and tri-level autorack.

Recesses 110 may run vertically (e.g., widthwise from one side of deck 108 to the other), horizontally (e.g., lengthwise from the front end of deck 108 to the back end of deck 108), or in any other suitable orientation. In certain embodiments, the corrugated sections (e.g., recesses 110) of deck 108 may be wider than the non-corrugated sections of deck 108.

Track assembly 104 of deck 108 may include a plurality of plates 112. Plates 112 may be integrated into a driving surface of deck 108. For example, each plate 112 may be positioned in one of a plurality of recesses 110 of deck 108. In such an example, plates 112 may be drilled, bolted, and/or welded into recesses 110. Plates 112 also may be attached to deck 108 by a hinge assembly such that one side of plates 112 may be lifted by an operator (e.g., for maintenance and cleaning). In certain embodiments, plates 112 may be made from steel. The present disclosure contemplates plates 112 being made from any suitable material and/or combination of suitable materials.

Each plate 112 may include a plurality of slots 114 that facilitate restraining various types of vehicles 103 to deck 108. In general, slots 114 of a plate 112 are arranged to accommodate vehicles of different widths. For example, each slot 114 of a plate 112 may correspond to a track width and/or type of vehicle (e.g., a vehicle 103 of a certain size, body style, and/or width). As such, a slot 114 of a plate 112 that is near a tire guide of a deck 108 may correspond to a small vehicle 103, such as a car, having a small track width (e.g., a width between the front tires and/or back tires). On the other hand, a slot 114 of a plate 112 that is near an edge of a deck 108 may correspond to a large vehicle 103, such as a truck, having a large track width. In certain embodiments, slots 114 may have a vertical orientation, horizontal orientation, or any other suitable orientation.

Slots 114 may be used to couple a strap assembly 106 to a track assembly 104. In particular, strap assembly 106 may engage track assembly 104 through one or more slots 114 to secure a tire 116 of a vehicle 103 to deck 108. For example, to secure tire 116 to deck 108, strap assembly 106 may be positioned on a portion of tire 116, a first end of strap assembly 106 may be coupled to track assembly 104 through a slot 114 in a first plate 112 on one side of tire 116, and a second end of strap assembly 106 may be coupled to track assembly 104 through a slot 114 in a second plate 112 on an opposing side of tire 116. In such an example, strap assembly 106 may then be tightened around the portion of tire 116, thereby securing tire 116 of the vehicle to deck 108. Thus, slots 114 facilitate securing a tire of a vehicle to a deck of a transport.

Track assembly 104 may also include tire guides 118. Tire guides 118 may facilitate the loading and unloading of vehicles 103 onto transport 102. For example, tire guides 118 may be used to guide tires 116 of vehicles 103 being loaded and unloaded onto transport 102 (e.g., via one or more decks 108). In certain embodiments, tire guides 118 may be coupled to a top surface of deck 108. For example, tire guides 118 may be welded and/or bolted to the top surface of deck 108.

Strap assembly 106 generally couples to track assembly 104 to secure a tire 116 of a vehicle 103 to deck 108 of transport 102. Strap assembly 106 may include a strap 120, an anchor 122 coupled to a first end of strap 120, and a ratchet 124 coupled to the second end of strap 120. In an example embodiment, securing a vehicle 103 to a deck 108 includes positioning strap 120 on a portion of a tire 116 of a vehicle 103, coupling anchor 122 to track assembly 104 through a first slot 114 in a first plate 112 on a first side of tire 116, and coupling ratchet 124 to track assembly 104 through a second slot 114 in a second plate 112 of track assembly 104 on a second side of tire 116. In certain embodiments, strap 120 may be tightened around tire 116 using ratchet 124. Although FIG. 2 illustrates system 100 securing two tires 116 to deck 108, system 100 may secure any number of tires 116 to deck 108. For example, system 100 may secure two tires 116 of a vehicle 103, three tires 116 of a vehicle 103, four tires 116 of a vehicle 103, and any other number of tires 116 of one or more vehicles 103 to deck 108.

Modifications, additions, or omissions may be made to system 100 without departing from the scope of the disclosure. In addition, system 100 may include any number of transports 102, track assemblies 104, strap assemblies 106, and decks 108. Furthermore, although particular examples of transports 102, track assemblies 104, strap assemblies 106, and decks 108 have been described, this disclosure contemplates any suitable transports 102, track assemblies 104, strap assemblies 106, and decks 108 comprising any suitable components configured in any suitable manner, according to particular needs. Moreover, transports 102, track assemblies 104, strap assemblies 106, decks 108, and any components thereof, may be separate from or integral to any component of FIG. 2. For example, slots 114 may be integrated into deck 108 (e.g., slots and/or holes formed in a driving surface of a deck). In such an example, deck 108 (and track assembly 104) may not include plates 112.

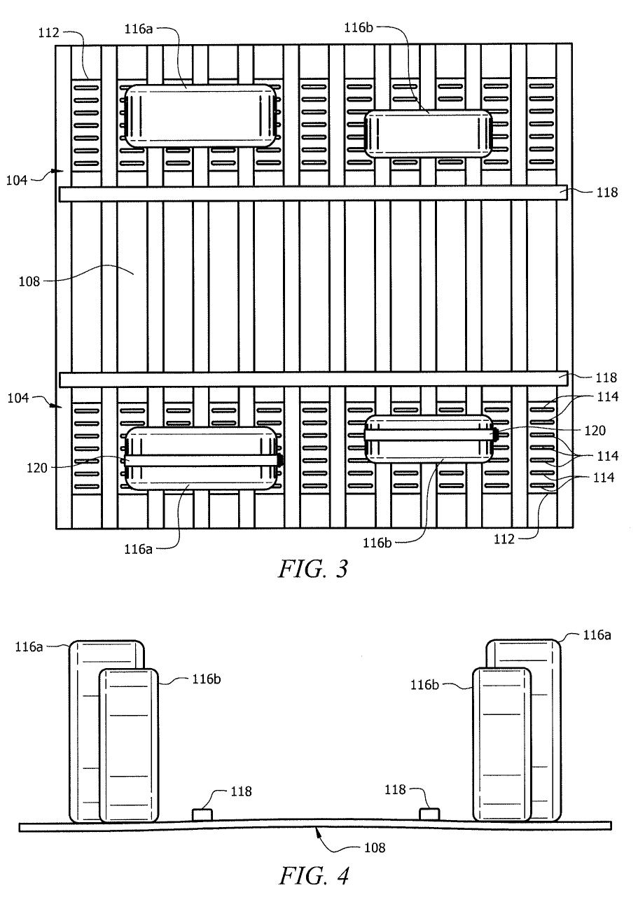

FIG. 3 illustrates a top view of an example of a system for restraining a vehicle in accordance with an embodiment of the present disclosure. As described above with respect to FIGS. 1 through 2, system 100 includes one or more strap assemblies 106 and one or more decks 108 each comprising track assembly 104. Track assembly 104 of deck 108 may facilitate securing vehicles 103 to deck 108 during shipment of the vehicles.

Track assembly 104 may include plates 112, slots 114, and/or tire guides 118. Plates 112 may be integrated into a driving surface of deck 108 and may each include slots 114 arranged to accommodate vehicles 103 of different widths, in certain embodiments. For example, a first vehicle 103 having a set of tires 116a may be larger than a second vehicle 103 having a set of tires 116b. In such an example, one or more tires 116a of the first vehicle may be secured to deck 108 via one or more slots 114 of one or more plates 112 located near an edge of deck 108, and one or more tires 116b of the second vehicle may be secured to deck 108 via one or more slots 114 of one or more plates 112 located near a tire guide 118. Thus, each slot 114 of a plate 112 may correspond to a track width and/or type of vehicle 103 (e.g., a vehicle 103 of a certain size, body style, and/or width). Although particular examples of track assembly 104, plates 112, and slots 114 have been described, the present disclosure contemplates any suitable track assembly 104, plates 112, and slots 114 comprising any suitable components configured in any suitable manner, according to particular needs. For example, slots 114 of track assembly 104 may be incorporated into the structure of deck 108 (e.g., slots and/or holes formed in a driving surface of a deck). In such an example, track assembly 104 (and deck 108) may not include plates 112. Further, although FIG. 3 illustrates slots 114 running in a direction parallel to tires 116, the present disclosure contemplates slots 114 running in any suitable direction, such as running in a direction perpendicular to tires 116.

Strap assembly 106 generally secures a tire 116 to deck 108 by engaging track assembly 104 through a first slot 114 of a first plate 112 and through a second slot 114 of a second plate 112. For example, a strap 120 of a strap assembly 106 may be positioned on a portion of tire 116 (e.g., a tire 116a and/or a tire 116b), a first end of strap 120 of strap assembly 106 may be coupled to track assembly 104 through a first slot 114 in a first plate 112 on one side of tire 116, and a second end of strap 120 of strap assembly 106 may be coupled to track assembly 104 through a second slot 114 in a second plate 112 on an opposing side of tire 116. In such an example, strap 120 (and strap assembly 106) may be tightened around the portion of tire 116, thereby securing tire 116 of the vehicle to deck 108. Although particular examples of strap assemblies 106 and straps 120 have been described, the present disclosure contemplates any suitable strap assemblies 106 and straps 120 comprising any suitable components configured in any suitable manner, according to particular needs.

FIG. 4 illustrates an end view of an example deck of a system for restraining a vehicle in accordance with an embodiment of the present disclosure. A deck 108 generally facilitates the loading, transportation, and/or unloading of vehicles associated with transport 102 (e.g., vehicles 103 being shipped via transport 102). Thus, deck 108 of transport 102 is configured to support one or more vehicles 103.

Deck 108 may be formed from steel and/or any other suitable material. Example decks 108 may include an adjustable deck of a convertible autorack, a removable deck of a convertible autorack, a deck of a tri-level autorack (e.g., a railcar comprising three decks), a deck of a bi-level autorack (e.g., a railcar comprising two decks), any other suitable deck, and/or any combination of the preceding. In other words, one or more decks 108 of a transport 102 may be adjustable and/or removable, and thereby may enable transport 102 to be used as a bi-level autorack and a tri-level autorack. According to various embodiments, deck 108 may be corrugated and may include a track assembly 104 and/or a plurality of recesses 110. Alternatively, deck 108 may be non-corrugated and may include a plurality of slots and/or holes formed in one or more driving surfaces of deck 108.

In certain embodiments, deck 108 may include a plurality of slots and/or holes incorporated into a driving surface of deck 108 of transport 102 and configured to accommodate any type of vehicle 103. For example, slots and/or holes may be formed in a driving surface of a deck 108. As another example, slotted plates may each be positioned in one of the plurality of recesses 110.

As illustrated, deck 108 may also include tire guides 118. Tire guides 118 may be coupled to a top surface of deck 108 and may facilitate the loading and unloading of vehicles onto transport 102. For example, tire guides 118 may be used to guide tires, such as tires 116a and 116b, during the loading and unloading of vehicles 103 onto transport 102.

In general, vehicles 103 of different widths may be loaded onto transport 102 and secured to deck 108. For example, a first vehicle 103 having a first set of tires 116a may be larger than a second vehicle 103 having a second set of tires 116b (e.g., the first vehicle may have a track width greater than the track width of the second vehicle). By using track assembly 108 and at least two strap assemblies 106, both the first and second vehicles 103 may be secured to the same deck 108.

Although particular examples of decks 108 and tire guides 118 have been described, this disclosure contemplates any suitable decks 108 and tire guides 118 comprising any suitable components configured in any suitable manner, according to particular needs. In addition, decks 108 and tire guides 118 may be separate from or integral to any component of FIG. 4. Moreover, it will be understood that transport 102 may include any number of decks 108 and may ship any number of vehicles 103. Furthermore, the present disclosure contemplates any type and any number of vehicles 103 being secured to deck 108.

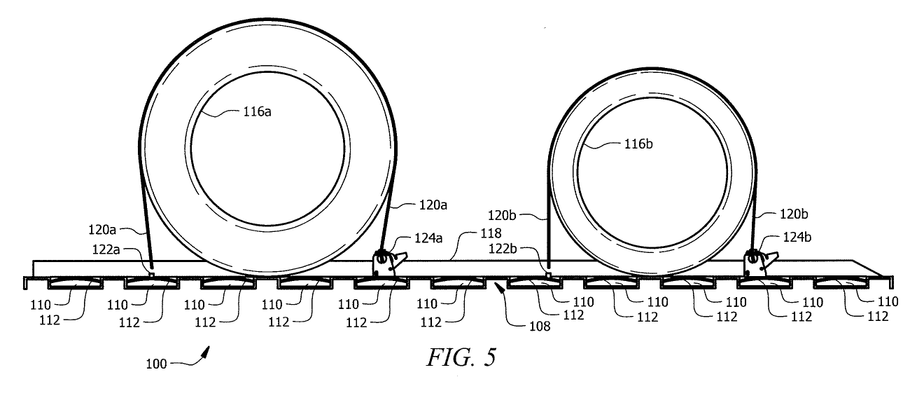

FIG. 5 illustrates a side view of an example system for restraining a vehicle in accordance with an embodiment of the present disclosure. System 100 may refer to a universal vehicle restraint system that may used to secure vehicles 103 of different widths to one or more decks 108 of a transport 102.

According to the illustrated embodiment, deck 108 may include recesses 110, plates 112, and tire guides 118 (which collectively may be referred to as a “track assembly 104”). Plates 112 facilitate securing various types and sizes of vehicles 103 to deck 108 and may be used to couple a strap assembly 106 to track assembly 104 (and deck 108). Example plates 112 may be made from steel and/or any other suitable material, and may each include a plurality of slots 114 arranged to accommodate vehicles 103 of different widths. In certain embodiments, each plate 112 may be positioned in a corresponding recess 110. For example, each plate 112 may be drilled, bolted, and/or welded into a corresponding recess 110.

Tire guide 118 may facilitate the loading and unloading of vehicles 103 onto deck 108. For example, tire guide 118 may be used to guide tire 116a of a first vehicle 103 and tire 116b of a second vehicle 103 while the first and second vehicles are being loaded and unloaded onto deck 108 of transport 102. In certain embodiments, tire guide 118 may be coupled to a top surface of deck 108. Alternatively, tire guide 118 may be integral to deck 108.

According to the illustrated embodiment, system 100 includes one or more straps 120, anchors 122, and ratchets 124 (which collectively may be referred to as one or more “strap assemblies”). Straps 120, anchors 122, and ratchets 124 may be configured to secure vehicles 103 to deck 108 and may couple to deck 108 through plates 112 of track assembly 104.

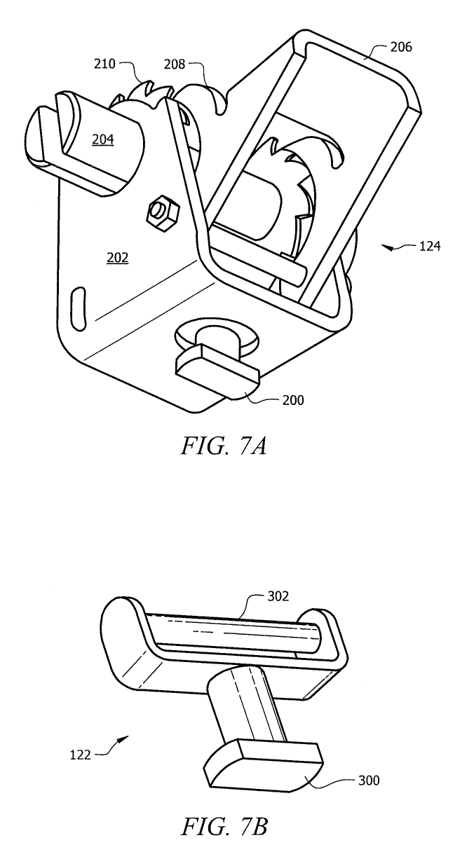

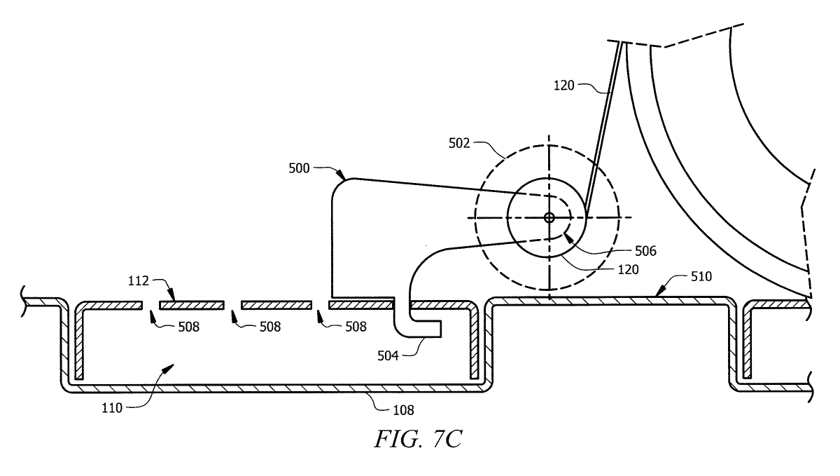

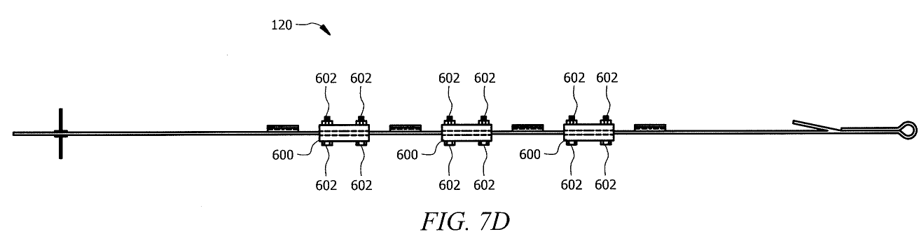

Strap 120 of strap assembly 106 may be configured to be positioned on a portion of a tire of a vehicle, such as tires 116a and 116b, to secure the tire of the vehicle to deck 108. Example straps 120 may be composed of one or more of nylon, rubber, cloth, and/or any other suitable material. In certain embodiments, strap 120 may include one or more cleats with raised fins and may be reversible (as discussed in more detail below with respect to FIG. 7D). According to the illustrated embodiment, a first end of strap 120 is coupled to anchor 122 and a second end of strap 120 is coupled to ratchet 124.

Anchor 122 of strap assembly 106 may be configured to be coupled to a plate 112 of track assembly 104. For example, anchor 122 may be coupled to a first plate 112 on a first side of a tire of a vehicle, such as tire 116a and/or tire 116b. In certain embodiments, anchor 122 may refer to a “T-pin anchor.” System 100 typically utilizes anchor 122 to secure one end of strap 120 to deck 108 through a first plate 112.

Ratchet 124 of strap assembly 106 may also be configured to be coupled to a plate 112 of track assembly 104. For example, ratchet 124 may be coupled to a second plate 112 on a second side of the tire of the vehicle, such as tire 116a and/or tire 116b. Ratchet 124 is generally operable to tighten strap 120 around a portion of a tire of a vehicle and may be used to secure another end of strap 120 to deck 108 through a second plate 112.

Thus, system 100 may secure vehicles 103 of different widths and sizes to deck 108 of transport 102. In particular, as illustrated in FIG. 5, a tire 116a of a first vehicle 103 (e.g., a truck, SUV, etc.) may be larger than a tire 116b of a second vehicle 103 (e.g., a compact car, sedan, etc.). Nevertheless, both tires 116a and 116b may be safely secured to deck 108 by coupling strap assembly 106 to track assembly 104 via corresponding slots 114 (as discussed in more detail above with respect to FIG. 3), thereby securing the vehicles in place on deck 108.

In certain embodiments, strap assembly 106 may include one or more wheel chocks configured to restrain a vehicle 103. In such embodiments, strap assembly 106 may not include one or more of strap 120, anchor 122, and/or ratchet 124. In particular, one or more wheel chocks may be used in combination with and/or instead of strap 120, anchor 122, and/or ratchet 124. Additionally, a wheel chock may be coupled to track assembly 104 on one side of a tire 116 of a vehicle 103 and/or both sides of a tire 116 of a vehicle 103. As discussed in more detail below with regard to FIG. 7C, similar to anchor 122 and ratchet 124, a wheel chock may be coupled to deck 108 through one or more slots 114.

In operation, strap assembly 106 may engage track assembly 104 through one or more plates 112 (e.g., via slots 114 of plates 112) to secure a tire 116 of a vehicle 103 (e.g., a tire 116a of a first vehicle 103 and/or a tire 116b of a second vehicle 103) to deck 108. To secure tires 116a and 116b to deck 108, a strap 120a may be positioned on a portion of tire 116a and strap 120b may be positioned on a portion of tire 116b. Next, anchor 122a may be coupled to deck 108 through a slot in a first plate 112 on a first side of tire 116a and anchor 122b may be coupled to deck 108 through a slot in a second plate 112 on a first side of tire 116b. Then, ratchet 124a may be coupled to deck 108 through a slot in a third plate 112 on a second side of tire 116a and ratchet 124b may be coupled to deck 108 through a slot in a fourth plate 112 on a second side of tire 116b. Once anchors 122a and 122b and ratchets 124a and 124b have been coupled to deck 108, ratchet 124a may be used to tighten strap 120a around tire 116a and ratchet 124b may be used to tighten strap 120b around tire 116b to secure tires 116a and 116b to deck 108.

The present disclosure contemplates one or more tires 116 of one or more vehicles 103 being coupled to deck 108 to secure the one or more vehicles to deck 108. In addition, although particular examples of deck 108, recesses 110, plates 112, straps 120, anchors 122, and ratchets 124 have been described, this disclosure contemplates any suitable deck 108, recesses 110, plates 112, straps 120, anchors 122, and ratchets 124 comprising any suitable components having any suitable configuration, according to particular needs. For example, slots 114 may be integrated into deck 108 (e.g., slots and/or holes formed in a driving surface of a deck). In such an example, deck 108 (and track assembly 104) may not include plates 112. Moreover, it should be understood that system 100 may secure vehicles 103 to decks 108 using any suitable components. For example, system 100 may use one or more wheel chocks to secure a vehicle 103 to a deck 108.

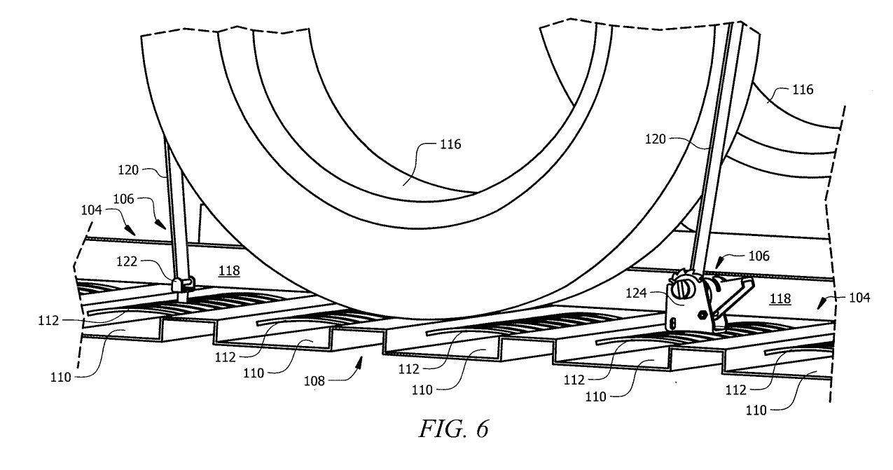

FIG. 6 illustrates a perspective view of an example of a strap assembly coupled to a track assembly to secure a vehicle to a deck of a transport in accordance with an embodiment of the present disclosure. Track assemblies 104 and strap assemblies 106 may be used to secure different types and sizes of vehicles 103 to one or more decks 108 of a transport, such as transport 102. As illustrated, deck 108 may be corrugated and may include a track assembly 104 and/or recesses 110. In certain embodiments, holes and/or slots may be formed in a driving surface of deck 108.

Track assembly 104 may comprise plates 112 and tire guides 118. In certain embodiments, plates 112 may be integrated into a driving surface of deck 108. For example, each plate 112 may be positioned in a corresponding recess 110. In such an example, plates 112 may be drilled and/or welded into a floor of deck 108. As another example, plates 112 may be recessed into corrugations of deck 108. In certain embodiments, plates 112 may be made from steel, any other suitable material, and/or any combination of the preceding. Each plate 112 generally comprises slots 114 arranged to accommodate vehicles 103 of different widths (as described above with regard to FIG. 2).

Strap assembly 106 may couple to track assembly 104 to secure a tire 116 of a vehicle 103 to deck 108 of transport 102. In certain embodiments, to secure tire 116 to deck 108, strap assembly 106 may engage track assembly 104 through one or more slots 114 in one or more plates 112. According to the illustrated embodiment, strap assembly 106 may include a strap 120, an anchor 122 coupled to a first end of strap 120, and a ratchet 124 coupled to a second end of strap 120.

In an example embodiment, securing a vehicle 103 to a deck 108 includes positioning strap 120 on a portion of a tire 116 of the vehicle, coupling anchor 122 to track assembly 104 through a first slot 114 in a first plate 112 on a first side of tire 116, and coupling ratchet 124 to track assembly 104 through a second slot 114 in a second plate 112 of track assembly 104 on a second side of tire 116. Strap 120 may then be tightened around the portion of tire 116 using ratchet 124. In certain embodiments, any other tires 116 of the vehicle may also be secured to deck 108, for example, using track assembly 104 and one or more other strap assemblies 106.

Although particular examples of track assembly 104 and strap assembly 106 have been described, this disclosure contemplates any suitable track assembly 104 and strap assembly 106 comprising any suitable components configured in any suitable manner, according to particular needs. In addition, track assembly 104 and strap assembly 106 may be separate from or integral to any component of FIG. 6. Moreover, although FIG. 6 illustrates only one track assembly 104 and one strap assembly 106 being used to secure one vehicle tire 116 to one deck 108, in certain embodiments, any suitable number of track assemblies 104 and strap assemblies 106 may be used to secure any suitable number of vehicle tires 116 to any suitable number of decks 108.

FIG. 7A illustrates an example ratchet of a system for restraining a vehicle in accordance with an embodiment of the present disclosure. Ratchet 124 is configured to be coupled to a track assembly 104 and is operable to tighten a strap assembly 106 around a tire of a vehicle 103 (such that the tire of the vehicle is restrained properly to reduce the risk of movement of the vehicle during transportation). Ratchet 124 may refer to a “ratchet anchor” and may be made from steel or aluminum. In certain embodiments, ratchet 124 may be a standard hand ratchet winch. In certain embodiments, ratchet 124 may be manually operated and/or operated with a wrench.

Ratchet 124 may include an anchor 200, housing 202, mandrel axle 204, foot release 206, ratchet pawls 208, and ratchet sprockets 210. Ratchet 124 may utilize anchor 200 to engage a track assembly 104 of deck 108 through a slot 114. In certain embodiments, housing 202 may be configured to protect mandrel axle 204, foot release 206, ratchet pawls 208, and/or ratchet sprockets 210.

Mandrel axle 204 may be used to couple one end of a strap 120 to ratchet 124 and may be operable to rotate to tighten strap 120 around a tire of a vehicle. In certain embodiments, mandrel axle 204 may rotate freely when foot release 206 of ratchet 124 is decoupled. In general, mandrel axle 204 may facilitate increasing the tension of strap 120 of strap assembly 104 on a tire of a vehicle, while foot release 206 may facilitate decreasing the tension of strap 120 on the tire of the vehicle.

Ratchet 124 may include ratchet pawls 208 that may lock rotation of mandrel axle 204. As such, ratchet 124 may not release the tightening force around a tire of a vehicle unless ratchet pawls 208 have been disengaged. In certain embodiments, ratchet pawls 208 may be configured such that a downward force rotates mandrel axle 204 and tightens strap assembly 104. In certain embodiments, when ratchet pawls 208 are engaged with ratchet sprockets 210, mandrel axle 204 may rotate freely in one direction. For example, ratchet pawls 208 may slip over ratchet sprockets 210 (even when engaged with the ratchet sprockets 210) if mandrel axle 204 is rotated one direction. On the other hand, ratchet pawls 208 may lock mandrel axle 204 in place if mandrel axle 204 is rotated another direction. In certain embodiments, foot release 206 may be used to disengage ratchet pawls 208 from ratchet sprockets 210, and thereby decrease the tension of strap 120 on the tire of the vehicle.

Although particular examples of ratchet 124 have been described, the present disclosure contemplates any suitable ratchet 124 comprising any suitable components configured in any suitable manner, according to particular needs. In addition, any component of ratchet 124 may be separate from or integral to any other component of ratchet 124 and strap assembly 106.

FIG. 7B illustrates an example anchor of a system for restraining a vehicle in accordance with an embodiment of the present disclosure. Anchor 122 is configured to be coupled to a track assembly 104. Anchor 122 may be made from steel or aluminum, or any other suitable material. Anchor 122 may include a t-pin anchor 300 and a pin 302.

Anchor 122 may utilize t-pin anchor 300 to engage a track assembly 104 of deck 108 through a slot 114 of a plate 112. Pin 302 may be used to couple anchor 122 to one end of a strap 120. Although particular examples of anchor 122 have been described, this disclosure contemplates any suitable anchor 122 comprising any suitable components configured in any suitable manner, according to particular needs. In addition, any component of anchor 122 may be separate from or integral to any other component of anchor 122 and strap assembly 106.

FIG. 7C illustrates a side view an example wheel chock of a system for restraining a vehicle in accordance with an embodiment of the present disclosure. Wheel chock 500 may be configured to couple to a deck 108 and facilitate restraining a vehicle 103 during transport. Wheel chock 500 may be made from steel or aluminum, and/or any other suitable material. According to the illustrated embodiment, wheel chock 500 may include a cantilever 502, anchor 504, and mandrel 506.

Wheel chock 500 may utilize anchor 504 to engage deck 108 through a slot 508 of a plate 112. Anchor 504 may comprise one or more teeth. The teeth may be round and/or rectangular, and may be forward facing teeth (e.g., face towards the tire of a vehicle). In certain embodiments, the teeth may allow wheel chock 500 to pivot up and down for engagement and disengagement from deck 108.

Slots 508 may refer to holes formed in, for example, plate 112, and may each be arranged to accommodate vehicles of different widths. According to the illustrated embodiment, slots 508 may run cross car (e.g., parallel to an axle of a vehicle 103). However, the present disclosure contemplates slots 508 having any suitable orientation. In certain embodiments, slots 508 may be substantially similar to slots 114 of FIG. 2.

Cantilever 502 may partially span a hill 510 of deck 108 and may be used to reduce and/or eliminate any track dead spots (areas where a wheel chock and/or ratchet cannot be installed close enough to a vehicle due to slot coverage (e.g., if hills 510 do not have any slots 508)). In other words, cantilever 502 may reach over a dead spot, such as a hill 510, thereby allowing wheel chock 500 to be installed close to tire 116 even when a side of tire 116 is positioned on top of a hill 510. Additionally, recesses 110 may have a width greater than hills 510, which may increase slot coverage and in turn reduce track dead spots. In certain embodiments, a foot may be positioned under cantilever 502 to help secure wheel chock 500 in place.

As illustrated, wheel chock 500 may be coupled to an end of a strap, such as a strap 120 of a strap assembly 106. In such embodiments, wheel chock 500 may have a mandrel 506 for receiving the end of strap 120 and tightening strap 120 around a tire of a vehicle 103. In alternative embodiments, wheel chock 500 may have a height sufficient to restrain a tire of a vehicle (e.g., tall enough to prevent the tire from rolling), and thus strap 120 (as well as anchor 122 and ratchet 124) may not be used. It should be understood that wheel chock 500 may be used in conjunction with and/or replace any component of strap assembly 106. For example, wheel chock 500 may be used instead of anchor 122 and/or ratchet 124. In such an example, wheel chock 500 may be coupled to the first end and/or the second end of strap 120.

Although FIG. 7C illustrates one wheel chock 500 coupled to deck 108, any number of wheel chocks 500 may be coupled to deck 108. As one example, a first wheel chock 500 may be coupled to deck 108 on a first side of a tire of a vehicle and a second wheel chock 500 may be coupled to deck 108 on a second side of a tire of a vehicle. Moreover, although particular examples of wheel chock 500 have been described, this disclosure contemplates any suitable wheel chock 500 comprising any suitable components configured in any suitable manner, according to particular needs. In addition, any component of wheel chock 500 may be separate from or integral to any other component of wheel chock 500, strap assembly 106, and system 100.

FIG. 7D illustrates a side view of an example strap of a system for restraining a vehicle in accordance with an embodiment of the present disclosure. A strap 120 of a strap assembly 106 may facilitate securing a vehicle 103 to a deck 108. In particular, strap 120 may be configured to be positioned on a portion of a tire 116 of a vehicle 103 to secure tire 116 of vehicle 103 to deck 108. Example straps 120 may be composed of one or more of nylon, rubber, cloth, and/or any other suitable material. In certain embodiments, a first end of strap 120 may be coupled to anchor 122 or chock assembly 500, and a second end of strap 120 may be coupled to ratchet 124 or another chock assembly 500.

According to the illustrated embodiment, strap 120 may be a reversible strap (e.g., double-sided) and may include cleats 600. Example cleats 600 may be composed of one or more of polymer, rubber, and/or any other suitable material. Each cleat 600 may have raised fins 602 located on both sides of the cleat. Fins 602 generally are configured to be inserted into the tread of a tire 116 to prevent strap 120 from sliding off of tire 116.

Although particular examples of strap 120 have been described, the present disclosure contemplates any suitable strap 120 comprising any suitable components configured in any suitable manner, according to particular needs. In addition, any component of strap 120 may be separate from or integral to any other component of strap 120 and strap assembly 106.

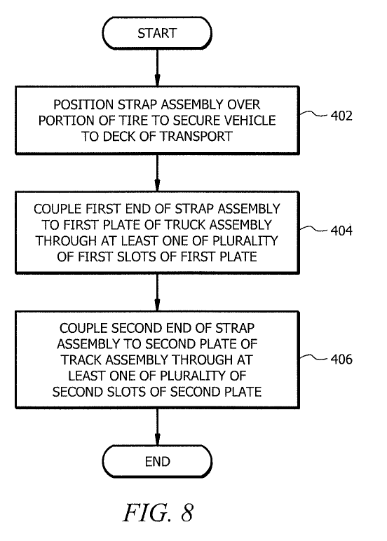

FIG. 8 illustrates an example method for restraining a vehicle in accordance with an embodiment of the present disclosure. The method begins at step 402 where a strap assembly 106 is positioned over a portion of a tire 116 of a vehicle 103 to secure the vehicle to a deck 108 of a transport 102 (e.g., a deck of a convertible autorack railcar). For example, a strap 120 of strap assembly 106 may be positioned over a portion of tire 116. In such an example, a first end of strap 120 may be coupled to an anchor 122 and a second end of strap 120 may be coupled to a ratchet 124.

In certain embodiments, deck 108 may be a corrugated deck comprising a track assembly 104 and/or a plurality of recesses 110. Track assembly 104 may include a plurality of plates, such as plates 112, that facilitate securing a vehicle 103 to deck 108. In such embodiments, each plate 112 of track assembly 104 may positioned in one of the plurality of recesses 110.

At step 404, a first end of strap assembly 106 may be coupled to a first plate 112 of the plurality of plates 112 of track assembly 104. To couple strap assembly 106 to first plate 112, the method may use one of a first plurality of slots 114 of first plate 112. For example, the first end of strap assembly 106 may be coupled to first plate 112 through at least one of the first plurality of slots 114. In certain embodiments, the method may use an anchor 122 of strap assembly 106 to couple strap assembly 106 to track assembly 104, for example, on a first side of tire 116.

A second end of strap assembly 106 may be coupled to a second plate 112 of the plurality of plates 112 of track assembly 104 at step 406. To couple strap assembly 106 to second plate 112, the method may use one of a second plurality of slots 114 of second plate 112. For example, the second end of strap assembly 106 may be coupled to second plate 112 through at least one of the second plurality of slots 114. In certain embodiments, ratchet 124 of strap assembly 106 may be used to couple strap assembly 106 to track assembly 104, for example, on a second side of tire 116. The method also may use ratchet 124 to tighten strap 120 (and strap assembly 106) around the portion of tire 116 of the vehicle, thereby properly restraining the vehicle to deck 108 for shipment.

In certain embodiments, the first and second plurality of slots 114 of the first and second plates 112, respectively, are each arranged to accommodate vehicles 103 of different widths. As such, the method may secure various types and sizes of vehicles 103 (e.g., SUVs, trucks, compact cars, sedans, etc.) to a single deck 108.

In certain embodiments, slots 114 may be integrated into deck 108 (e.g., slots and/or holes formed in a driving surface of a deck). In such embodiments, deck 108 (and track assembly 104) may not include plates 112.

After performing step 406, the method may end.

Some of the steps illustrated in FIG. 8 may be combined, modified, or deleted where appropriate, and additional steps may also be added to the flowchart. Additionally, steps may be performed in any suitable order without departing from the scope of the disclosure. For example, the method may perform step 406 before performing step 402 and/or step 404. As another example, step 404 may be performed before step 402 and/or step 406.

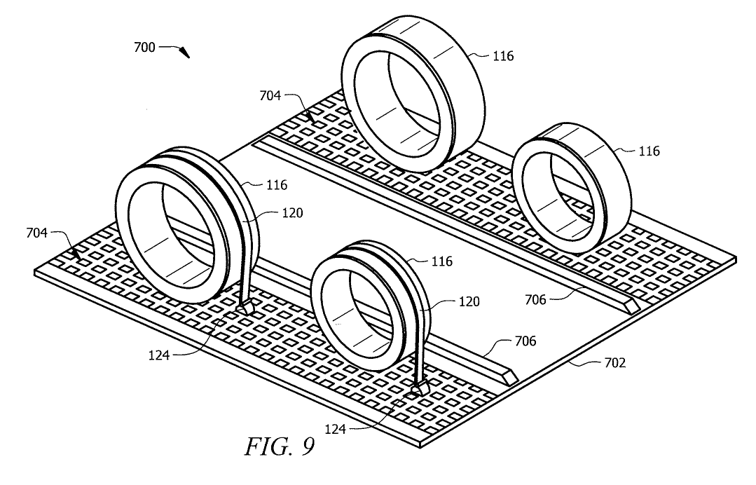

FIG. 9 illustrates a perspective view of another example deck of a system for restraining a vehicle in accordance with an embodiment of the present disclosure. System 700 may include a deck 702 and one or more strap assemblies 106 (of FIG. 2). In general, system 700 facilitates securing vehicles of different widths (e.g., vehicles 103 of different sizes with different track widths) to one or more decks 702 of a transport, such as transport 102 (of FIG. 1A).

Example decks 702 may be formed from steel and/or any other suitable material, and may be non-corrugated decks. In certain embodiments, one or more decks 702 may be adjustable and/or removable, thereby enabling transport 102 to be used as a bi-level and tri-level autorack. Deck 702 may include slots 704 and tire guides 706, and may be configured to support one or more vehicles 103. Tire guides 706 may be substantially similar to tire guides 118 (of FIG. 2).

Slots 704 may be integrated into a driving surface of deck 702 and facilitate restraining various types of vehicles 103 to deck 702. In general, each row of slots 704 are arranged to accommodate vehicles of different widths. For example, each slot 704 may correspond to a track width and/or type of vehicle (e.g., a vehicle 103 of a certain size, body style, and/or width). As such, a slot 704 that is near a tire guide 706 of deck 702 may correspond to a small vehicle 103, such as a car, having a small track width (e.g., a width between the front tires and/or back tires). On the other hand, a slot 704 that is near an edge of deck 702 may correspond to a large vehicle 103, such as a truck, having a large track width. In certain embodiments, the driving surface comprising slots 704 may be hinged to allow the driving surface (and slots 704) to be lifted by an operator for cleaning and maintenance.

Slots 704 may be used to couple a strap assembly 106 to a deck 702. In particular, strap assembly 106 may engage deck 702 through one or more slots 704 to secure a tire 116 of a vehicle 103 to deck 702. For example, to secure tire 116 to deck 702, a strap 120 of strap assembly 106 may be positioned on a portion of tire 116, a first end of strap 120 may be coupled to deck 702 through a first slot 704 (via an anchor 122 of strap assembly 106 or a wheel chock 500 (of FIG. 7C)) on one side of tire 116, and a second end of strap 120 may be coupled to deck 702 through a second slot 704 (via a ratchet 124 of strap assembly 106 or a wheel chock 500) on an opposing side of tire 116. In such an example, strap 120 may then be tightened around the portion of tire 116 using ratchet 124 and/or wheel chock 500, thereby securing tire 116 of the vehicle to deck 702. Thus, slots 704 generally provide a wide range of locations to attach a strap assembly 106 and/or a wheel chock 500 to deck 702.

In certain embodiments, deck 702 may include a water management system configured to collect water, dust, and other debris, and thereby prevent any water from dripping and debris from falling onto vehicles 103 loaded onto a deck below deck 702. In such embodiments, the water management system may be located underneath slots 704 and may extend cross car.

Modifications, additions, or omissions may be made to deck 702 without departing from the scope of the disclosure. In addition, deck 702 may include any number of slots 704, tire guides 706, strap assemblies 106, and any components of FIGS. 2-7D. Furthermore, although particular examples of deck 702, slots 704, tire guides 706, and strap assemblies 106 have been described, this disclosure contemplates any suitable deck 702, slots 704, tire guides 706, and strap assemblies 106 comprising any suitable components configured in any suitable manner, according to particular needs. Moreover, deck 702, slots 704, tire guides 706, and strap assemblies 106, and any components thereof, may be separate from or integral to any component of FIG. 9.

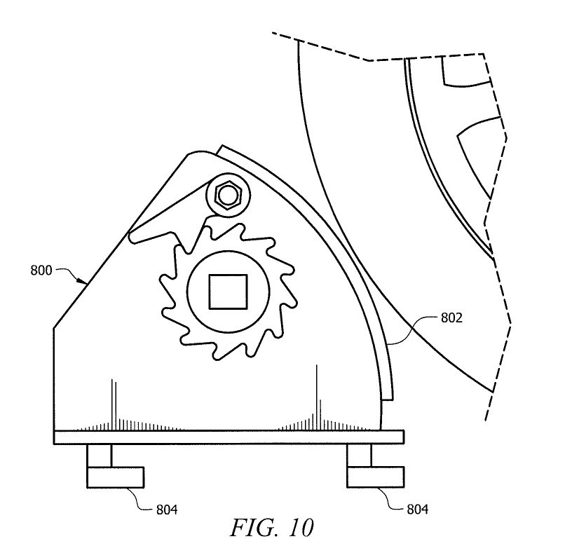

FIG. 10 illustrates a side view of an example chock assembly of a system for restraining a vehicle in accordance with an embodiment of the present disclosure. Chock assembly 800 may be configured to couple to a deck 108 and/or a deck 702 to facilitate restraining a vehicle 103 during transport. Chock assembly 800 may be made from steel or aluminum, and/or any other suitable material. According to the illustrated embodiment, chock assembly 800 may include a chock face 802 and anchors 804.

Chock face 802 may be a curved chock surface and may be configured to abut or closely abut a side of a tire 116 of a vehicle 103. In certain embodiments, a chock face 802 (and a chock assembly 800) may be positioned on either or both sides of a tire 116 of a vehicle 103 to secure tire 116 of vehicle 103 to a deck. Although FIG. 10 illustrates chock assembly 800 as including only one chock face 802, chock assembly 800 may include any number of chock faces 802 configured in any suitable manner

Chock assembly 800 may utilize anchors 804 to engage a deck, such as deck 108 and/or deck 702, through one or more slots, such as slots 114 and/or slots 704. Anchors 804 may refer to teeth, in certain embodiments. The teeth may be round and/or rectangular, and may be forward facing teeth (e.g., face towards the tire of a vehicle). In certain embodiments, the teeth may allow chock assembly 800 to pivot up and down for engagement and disengagement from a deck. Although FIG. 10 illustrates chock assembly 800 as including only two anchors 804, chock assembly 800 may include any number of anchors 804 configured in any suitable manner. For example, chock assembly 800 may include one anchor 804, three anchors 804, four anchors 804, and so on.

Chock assembly 800 may have a height sufficient to restrain a tire of a vehicle (e.g., tall enough to prevent the tire from rolling). In particular, a vehicle 103 may be restrained to a deck 108 and/or a deck 702 using one or more chock assemblies 800, rather than one or more strap assemblies 106. For example, a chock assembly 800 may be coupled to a deck on one or both sides of a tire 116 of a vehicle 103 to prevent tire 116 of vehicle 103 from rolling and thereby secure tire 116 in place. It should be understood that the present disclosure contemplates using one or more chock assemblies 800 in conjunction with and/or instead of any component of strap assembly 106. For example, a chock assembly 800 may be used instead of anchor 122 and/or ratchet 124. In such an example, chock assembly 800 may be coupled to a first end and/or a second end of a strap 120

Although FIG. 10 illustrates one chock assembly 800, any number of chock assemblies 800 may be used to restrain any number of vehicles 103 to decks 108 and decks 702. Moreover, although particular examples of chock assembly 800 have been described, this disclosure contemplates any suitable chock assembly 800 comprising any suitable components configured in any suitable manner, according to particular needs. In addition, any component of chock assembly 800 may be separate from or integral to any other component of chock assembly 800 and strap assembly 106.

Teachings of the present disclosure may be satisfactorily used to facilitate restraining one or more vehicles to one or more decks of a transport. Modifications, additions, or omissions may be made to the systems described herein without departing from the scope of the present disclosure. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the present disclosure. For example, the steps may be combined, modified, or deleted where appropriate, and additional steps may be added. Additionally, the steps may be performed in any suitable order without departing from the scope of the present disclosure.

Although embodiments of the present disclosure and their advantages have been described in detail, it should be understood that various changes, substitutions and alternations can be made herein without departing from the spirit and scope of the present disclosure as defined by the following claims. Moreover, although particular embodiments have been described herein, a myriad of changes, variations, alterations, transformations, substitutions, and modifications may be suggested to one skilled in the art, and it is intended that the present disclosure encompass such changes, variations, alterations, transformations, substitutions, and modifications as fall within the scope of the appended claims. For example, although particular embodiments of the disclosure have been described with reference to a number of elements included in a system for restraining a vehicle, these elements may be combined, rearranged or positioned in order to accommodate particular storage requirements or needs. Various embodiments contemplate great flexibility in the vehicle restraint system and its components. Additionally, while some embodiments are described with respect to an autorack, particular embodiments may be used for any type of transport.

What is claimed is:

1. A system comprising:
a deck of a transport, the deck comprising:
a track assembly comprising a plurality of plates; and
a strap assembly configured to secure a vehicle to the deck of the transport, and configured to be coupled to the deck of the transport through a first plate of the plurality of plates of the track assembly and a second plate of the plurality of plates of the track assembly.

2. The system of claim 1, wherein:
the deck is a corrugated deck comprising a plurality of recesses; and
each of the plurality of plates of the track assembly is positioned in one of the plurality of recesses.

3. The system of claim 1, wherein:
the first plate of the plurality of plates of the track assembly comprises a plurality of first slots;
the second plate of the plurality of plates of the track assembly comprises a plurality of second slots;
a first end of the strap assembly is configured to be coupled to the first plate of the plurality of plates of the track assembly through at least one of the plurality of first slots; and
a second end of the strap assembly is configured to be coupled to the second plate of the plurality of plates of the track assembly through at least one of the plurality of second slots.

4. The system of claim 3, wherein the plurality of first slots of the first plate of the plurality of plates of the track assembly and the plurality of second slots of the second plate of the plurality of plates of the track assembly are each arranged to accommodate vehicles of different widths.

5. The system of claim 1, wherein the strap assembly is configured to be positioned on a portion of a tire of the vehicle to secure the vehicle to the deck of the transport.

6. The system of claim 1, wherein the strap assembly comprises:
an anchor coupled to a first end of a strap; and
a ratchet coupled to a second end of the strap.

7. The system of claim 6, wherein the anchor is configured to be coupled to the track assembly on a first side of a tire of the vehicle.

8. The system of claim 7, wherein the ratchet is configured to be coupled to the track assembly on a second side of the tire of the vehicle.

9. The system of claim 6, wherein the ratchet is operable to tighten the strap around a portion of a tire of the vehicle.

10. The system of claim 6, wherein the strap comprises a plurality of cleats, each of the plurality of cleats comprising a plurality of fins.

11. The system of claim 1, wherein the transport is a railcar.

12. The system of claim 11, wherein the railcar is a convertible autorack railcar.

13. The system of claim 1, wherein the strap assembly comprises one or more wheel chocks.

14. A method comprising:
positioning a strap assembly over a portion of a tire of a vehicle to secure the vehicle to a deck of a transport, wherein:
the deck comprises a track assembly; and
the track assembly comprises a plurality of plates;
coupling a first end of the strap assembly to a first plate of the plurality of plates of the track assembly; and
coupling a second end of the strap assembly to a second plate of the plurality of plates of the track assembly.

15. The method of claim 14, wherein:
the first end of the strap assembly is coupled to the first plate of the plurality of plates of the track assembly on a first side of a tire of the vehicle; and
the second end of the strap assembly is coupled to the second plate of the plurality of plates of the track assembly on a second side of the tire of the vehicle.

16. The method of claim 14, wherein:
the first plate of the plurality of plates of the track assembly comprises a plurality of first slots;
the second plate of the plurality of plates of the track assembly comprises a plurality of second slots;
coupling the first end of the strap assembly to the first plate of the plurality of plates of the track assembly comprises coupling the first end of the strap assembly to the first plate of the plurality of plates of the track assembly through at least one of the first plurality of slots of the first plate of the plurality of plates of the track assembly; and
coupling the second end of the strap assembly to the second plate of the plurality of plates of the track assembly comprises coupling the second end of the strap assembly to the second plate of the plurality of plates of the track assembly through at least one of the second plurality of slots of the second plate of the plurality of plates of the track assembly.

17. The method of claim 16, wherein the plurality of first slots of the first plate of the plurality of plates of the track assembly and the plurality of second slots of the second plate of the plurality of plates of the track assembly are each arranged to accommodate vehicles of different widths.

18. The method of claim 14, further comprising tightening the strap assembly around the portion of the tire of the vehicle using a ratchet.

19. The method of claim 14, wherein the strap assembly comprises:
an anchor coupled to a first end of a strap; and
a ratchet coupled to a second end of the strap.

20. The method of claim 19, wherein:
positioning the strap assembly over the portion of the tire of the vehicle to secure the vehicle to the deck of the transport comprises positioning the strap of the strap assembly over the portion of the tire of the vehicle to secure the vehicle to the deck of the transport;
coupling the first end of the strap assembly to the first plate of the plurality of plates of the track assembly comprises coupling the anchor of the strap assembly to the first plate of the plurality of plates of the track assembly; and
coupling the second end of the strap assembly to the second plate of the plurality of plates of the track assembly comprises coupling the ratchet of the strap assembly to the second plate of the plurality of plates of the track assembly.

21. The method of claim 14, wherein:
the deck is a corrugated deck comprising a plurality of recesses; and
each of the plurality of plates of the track assembly is positioned in one of the plurality of recesses.

22. The method of claim 14, wherein the transport is a convertible autorack railcar.

23. A system comprising:
a deck of a transport, the deck comprising:
a plurality of slots; and
a strap assembly configured to secure a vehicle to the deck of the transport, and configured to be coupled to the deck of the transport through a first slot of the plurality of slots of the deck and a second slot of the plurality of slots of the deck.

24. The system of claim 23, wherein the deck further comprises a water management system.

25. The system of claim 23, wherein:
a first end of the strap assembly is configured to be coupled to the deck of the transport through the first slot of the plurality of slots of the deck; and
a second end of the strap assembly is configured to be coupled to the deck of the transport through the second slot of the plurality of slots of the deck.

26. The system of claim 23, wherein the plurality of slots of the deck are each arranged to accommodate vehicles of different widths.

27. The system of claim 23, wherein the strap assembly is configured to be positioned on a portion of a tire of the vehicle to secure the vehicle to the deck of the transport.

28. The system of claim 23, wherein the strap assembly comprises:
an anchor coupled to a first end of a strap; and
a ratchet coupled to a second end of the strap.

29. The system of claim 28, wherein the anchor is configured to be coupled to the first slot on a first side of a tire of the vehicle.

30. The system of claim 29, wherein the ratchet is configured to be coupled to the second slot on a second side of the tire of the vehicle.

31. The system of claim 28, wherein the ratchet is operable to tighten the strap around a portion of a tire of the vehicle.

32. The system of claim 28, wherein the strap comprises a plurality of cleats, each of the plurality of cleats comprising a plurality of fins.

33. The system of claim 23, wherein the transport is a railcar.

34. The system of claim 33, wherein the railcar is a convertible autorack railcar.

35. The system of claim 23, wherein the strap assembly comprises one or more wheel chocks.
